(19) United States
(12) Patent Application Publication
(10) Pub. No.: US 2025/0377574 A1
(43) Pub. Date: Dec. 11, 2025

(54) CRYSTAL WAVEGUIDE FOR FREQUENCY CONVERSION

(71) Applicant: KLA Corporation, Milpitas, CA (US)

(72) Inventors: Kelly Mauser, Santa Clara, CA (US); Yung-Ho Alex Chuang, Cupertino, CA (US); John Fielden, Los Altos, CA (US); Xuefeng Liu, San Jose, CA (US); Ding Ding, Claremont, CA (US); Baigang Zhang, San Jose, CA (US); Sisir Yalamanchili, Milpitas, CA (US)

(21) Appl. No.: 19/006,860

(22) Filed: Dec. 31, 2024

Related U.S. Application Data
(60) Provisional application No. 63/656,120, filed on Jun. 5, 2024.

(51) Int. Cl. G02F 1/377; G02F 1/35; G02F 1/355; H01S 3/00; H01S 3/109

(52) U.S. Cl. CPC G02F 1/377; G02F 1/3544; G02F 1/3551; G02F 1/3558; H01S 3/0092; H01S 3/109

(57) ABSTRACT

A system for frequency conversion is disclosed. The system includes a nonlinear crystal waveguide formed from strontium tetraborate (SBO) or lithium triborate (LBO). This system is used for second harmonic generation or sum-frequency generation to produce laser output light having wavelengths in the range of about 120-200 nm. Inspection systems, lithography systems and cutting systems incorporating the frequency conversion system are also described.

### CROSS-REFERENCE TO RELATED APPLICATIONS

The present claims the benefit of U.S. Provisional Application No. 63/656,120, filed on Jun. 5, 2024, which is incorporated herein by reference in the entirety.

### TECHNICAL FIELD

The present disclosure relates to the construction of waveguides composed of nonlinear crystals or adjacent to nonlinear crystals capable of generating light having DUV and VUV wavelengths, and more particularly to the construction of nonlinear crystal waveguides capable of generating light in the range of approximately 120 nm to 200 nm and to systems that use such nonlinear crystals. Systems incorporating the nonlinear crystal waveguides disclosed herein may be configured to inspect samples, such as photomasks, reticles, and semiconductor wafers. In alternative embodiments, systems incorporating the nonlinear crystal waveguides disclosed herein may be configured as lithography systems for exposing patterns on substrates such as a semiconductor wafers, may be configured for cutting or drilling substrates, or may be configured for ablating or cutting biological tissue, such as in corrective eye surgery.

### BACKGROUND

As dimensions of semiconductor devices shrink, the size of the smallest particle or pattern defect that can cause a device to fail also shrinks. Hence, a need arises for detecting smaller particles and defects on patterned and unpatterned semiconductor wafers and reticles. The intensity of light scattered by particles smaller than the wavelength of that light generally scales as a high power of the dimensions of that particle. For example, the total scattered intensity of light from an isolated small spherical particle scales proportionally to the sixth power of the diameter of the sphere and inversely proportional to the fourth power of the wavelength. Because of the increased intensity of the scattered light, shorter wavelengths will generally provide better sensitivity for detecting small particles and defects than longer wavelengths.

Since the intensity of light scattered from small particles and defects is generally very low, high illumination intensity is required to produce a signal that can be detected in a very short time. For example, average light source power levels of 1 W or more may be required. At these high average power levels, a high pulse repetition rate is desirable as the higher the repetition rate, the lower the energy per pulse and hence the lower the risk of damage to the system optics or the article being inspected. The illumination needs for inspection and metrology are often best met by continuous wave (CW) light sources. A CW light source has a constant power level, which avoids the peak power damage issues and allows for images or data to be acquired continuously. However, in many cases, mode-locked lasers (also called quasi-CW lasers) with repetition rates of about 50 MHz or higher can be useful because the high repetition rate means that the energy per pulse can be low enough to avoid damage for many metrology and inspection applications. The higher peak power of a mode locked laser as compared with a CW laser of the same average power level can allow more efficient and simpler frequency conversion.

Pulsed lasers for generating vacuum ultraviolet (VUV) light are known in the art. Prior-art lasers for generating light at 193 nm are well known. Unfortunately, such lasers are not well suited to inspection applications because of their low laser pulse repetition rates and their use of toxic and corrosive gases in their lasing medium, which leads to high cost of ownership.

Solid-state deep ultraviolet (DUV) lasers are desirable due to their higher possible repetition rates, possibility for CW generation, and no need for toxic liquids or gases. There are a number of crystals that can be used for DUV frequency conversion. For example, beta barium borate (BBO) and cesium lithium borate (CLBO) crystals are common crystals for ultraviolet (UV) frequency conversion. Both materials have some capability for phase-matching to produce UV light but suffer from various disadvantages for high-power VUV frequency conversion. The damage threshold of BBO is relatively low when exposed to high-intensity DUV radiation. Furthermore, BBO is not transmissive below approximately 190 nm. CLBO can have a higher damage threshold than BBO, but is hygroscopic requiring great care during handling, processing, and operation. Additionally, CLBO shows increased absorption for wavelengths shorter than approximately 185 nm.

Other, less common, crystals have been explored for DUV frequency conversion. For example, potassium beryllium fluoroborate (KBBF) (KBe₂BO₃F₂) and others with beryllium fluoroborate (ABe₂BO₃F₂), where A=Na, K, Rb, Cs, Tl, NH₄, have absorption edges between 147-155 nm, decent nonlinear coefficients, and large enough birefringence to make phase matching possible for 161-202 nm. Second harmonic generation of 200 nm light with 1.2 W power has been shown in KBBF, however, transparency begins to decrease for wavelengths shorter than 200 nm, making high power generation less likely for shorter wavelengths. Furthermore, the largest reported KBBF crystal grown is 3.7 mm, which limits the application potential of this material.

Other DUV transmissive crystals exist, namely strontium beryllium borate (SBBO) (Sr₂Be₂B₂O₇), strontium pentafluoroaluminate (SrAlF₅), and boron phosphate (BPO₄), among others, but these crystals suffer from unstable crystal structures, difficulty with growth, toxic precursors, or need further development of growth methods and study of damage threshold and nonlinear processes.

Other nonlinear crystals transparent in the DUV do not have large enough birefringence to allow for birefringent phase matching in the DUV. However, quasi-phase matching is possible for many of these crystals. For example, barium magnesium fluoride (BaMgF₂) and strontium magnesium tetrafluoride (SrMgF₄) have high transmission for wavelengths as short as approximately 125 nm and are ferroelectric and so can be periodically poled for quasi-phase matching, but the nonlinear coefficients in these materials are too small to overcome losses from surface scattering or absorption in the material. Furthermore, periodic poling using the ferroelectric properties of a crystal do not always produce perfectly straight boundaries between poling domains, which is acceptable for infrared (IR) or visible quasi-phase-matching, but is detrimental in VUV/DUV quasi-phase-matching due to a smaller poling period caused by a greater mismatch in index of refraction between the shorter wavelengths involved, as found in Sellmeier index of refraction models of the transparent region of dielectric nonlinear frequency conversion crystals. There are currently no commercially available periodically-poled crystals for VUV/DUV frequency conversion of any dimension.

It is necessary to create VUV/DUV transmissive frequency conversion crystals with sufficient conversion efficiency to produce high-power VUV/DUV light sources. However, a high quality, commercial method of growing large boules of VUV/DUV frequency conversion crystals does not exist.

Therefore, a need arises for a frequency conversion device created from small amounts of VUV/DUV crystals, that generates DUV radiation near a wavelength of 120-200 nm and avoids many or all of the disadvantages of prior art crystals, and is suitable for use in systems configured for inspection of samples, configured for exposing a pattern into photoresist on a substrate, or configured for drilling, cutting or ablating materials including biological tissue.

### SUMMARY

An optical system is disclosed, in accordance with one or more embodiments of the present disclosure. In embodiments, the optical system includes an illumination source configured to generate illumination having a wavelength between 120 nm and 200 nm; and an optical sub-system configured to direct the illumination from the illumination source onto a sample. In embodiments, the illumination source comprises a first fundamental laser configured to generate a fundamental laser beam having a corresponding fundamental frequency and a fundamental wavelength between 720 nm and 800 nm; and two or more frequency doubling stages, the two or more frequency doubling stages including at least an intermediate frequency doubling stage and a final frequency doubling stage, the intermediate frequency doubling stage is configured to receive the first fundamental frequency and generate a second harmonic light having a second harmonic frequency, the final frequency doubling stage is configured to generate laser output light from the second harmonic light, the final frequency doubling stage includes a nonlinear crystal waveguide configured to double a frequency of the second harmonic light. In embodiments, the nonlinear crystal waveguide is composed of at least one of strontium tetraborate (SBO), or lithium triborate (LBO), wherein the nonlinear crystal waveguide is configured to phase match or quasi-phase-match the second harmonic frequency and the laser output light.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure

### BRIEF DESCRIPTION OF DRAWINGS

The numerous advantages of the disclosure may be better understood by those skilled in the art by reference to the accompanying figures.

FIG. 1 is a simplified block diagram of an optical system, in accordance with one or more embodiments of the present disclosure.

FIG. 2 is a simplified block diagram depicting a laser assembly, in accordance with one or more embodiments of the present disclosure.

FIG. 3 is a simplified diagram depicting waveguide geometries, in accordance with one or more embodiments of the present disclosure.

FIG. 4 is a plot depicting a calculation of effective index as a function of slab waveguide height, in accordance with one or more embodiments of the present disclosure.

FIG. 5 is a plot of second harmonic power generated as a function of distance along a slab waveguide, in accordance with one or more embodiments of the present disclosure.

FIG. 6 is a simplified diagram depicting a frequency conversion waveguide with sections of alternating poling or crystallinity, in accordance with one or more embodiments of the present disclosure.

FIG. 7 is a simplified diagram depicting a frequency conversion amplifier, in accordance with one or more embodiments of the present disclosure.

FIGS. 8A-8E illustrate simplified diagrams depicting outcoupling prism geometries, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to an improvement in creating nonlinear crystal waveguides of SBO and LBO for semiconductor inspection and optical systems.

SBO is a material that has gained increased interest for DUV frequency generation. The space group of SBO is Pnm2₁ and the point group is mm2, indicating that a d₃₃ nonlinear coefficient may exist and be utilized for quasi-phase matching. The natural crystallographic coordinates of SBO are a=4.4255 Å, b=10.709 Å, and c=4.2341 Å. The crystallographic coordinates in a rectangular frame of reference are X, Y, and Z, and X, Y, Z correspond to a, b, c. The optical coordinates are x, y, and z, and x, −y, z correspond to b, a, c respectively. The z optical coordinate corresponding to the n_{z} index of refraction is along the 2₁ symmetry axis of SBO. In the case of quasi-phase matching (QPM) of SBO, the alternating axis is the c-axis in order to access the high d₃₃ nonlinear coefficient. This d₃₃ nonlinear coefficient has been measured as 1.5 pm/V for 800 nm to 400 nm frequency doubling. Furthermore, SBO has DUV transparency for wavelengths as short as 125 nm, and frequency conversion to this wavelength has been shown. SBO has a UV light-induced damage threshold at 266 nm of 16.4 J/cm², significantly higher than that of calcium fluoride (CaF₂) (11.4 J/cm²) and silica (4.8 J/cm²). While biaxial, SBO is nearly isotropic and so birefringent phase matching is not possible for frequency conversion in the DUV. Because of the high d₃₃ nonlinear coefficient, SBO is a candidate for quasi-phase matching, in which the fundamental and second harmonic are polarized parallel to each other and parallel to the c-axis. The phase mismatch caused by the different index of the fundamental and higher harmonic is compensated by alternatively flipping the direction of the c-crystal-axis of the material by 180 degrees, so that the phase difference between the harmonics is alleviated by the different sign of the nonlinear coefficient.

It is noted that SBO exhibits unique optical and mechanical properties. The transparency range of SBO is 130-3200 nm in wavelength. This broad transparency range covers VUV, DUV, visible, and near infrared (IR) wavelength ranges. The VUV and DUV ranges are of particular interest to semiconductor inspection and metrology. It is also noted that the transmittance is high. For instance, the transmittance exceeds 80% from about 250 nm to about 2500 nm. This high transmittance makes SBO a good candidate for frequency generation especially for the UV wavelength range. If SBO is grown in optimal conditions, a better transmission curve can be obtained: the transmittance can reach more than 80% for wavelengths longer than 200 nm and more than 50% for 130 to 200 nm.

It is further contemplated herein that LBO is a well-studied and commercially available nonlinear optic material. LBO belongs to the Pna2₁ space group and mm2 point group, indicating that a d₃₁, d₃₂, d₃₃ d₂₄, and d₁₅, nonlinear coefficient may exist and could be used for quasi-phase matching. The natural crystallographic coordinates are a=7.3788 Å, b=8.4473 Å, and c=5.1395 Å. The crystallographic coordinates in a rectangular frame of reference are X, Y, and Z, and X, Y, Z correspond to a, b, c. The optical coordinates are x, y, and z, and x, y, z correspond to b, c, a respectively. The y optical coordinate corresponding to the n_{y} index of refraction is along the 2₁ symmetry axis of LBO. The c-axis should be alternated in each plate to access the high d₃₁ and d₁₅ nonlinear coefficients. The d₃₁, d₃₂, and d₃₃ nonlinear coefficients have been measured as 0.85 pm/V, −0.67 pm/V, and 0.04 pm/V, respectively, at 1064 nm. Assuming Kleinman symmetry and neglecting absorption, the d₂₄ nonlinear coefficient is equal to the d₃₂ nonlinear coefficient and the d₁₅ nonlinear coefficient is equal to the d₃₁ nonlinear coefficient. The transparency range of LBO is 160 nm-2300 nm, and has sufficient birefringence to perform phase-matched frequency conversion for wavelengths as short as approximately 266 nm. Birefringent phase-matching is not possible for wavelengths less than 200 nm, but quasi-phase matching can be used. The d₃₃ nonlinear coefficient is too small for efficient conversion in practice, but the d₃₁ and d₁₅ nonlinear coefficients are large enough for practical quasi-phase matching. For type I phase matching utilizing the d₃₁ nonlinear coefficient, the fundamental is polarized parallel to the a-crystallographic axis and produces a second harmonic polarized parallel to the c-crystallographic axis. For type II phase matching utilizing the d₁₅ nonlinear coefficient, one or part of the fundamental beams is polarized parallel to the c-crystallographic axis and one or part of the fundamental beams is polarized parallel to the a-crystallographic axis, and produces a second harmonic or higher frequency light polarized parallel to the a-crystallographic axis. The phase mismatch caused by the different index of the fundamental(s) and higher harmonic or frequency is compensated by alternatively flipping the direction of the c-crystal-axis of the material by 180 degrees, so that the phase difference between the frequencies involved is alleviated by the different sign of the nonlinear coefficient. The damage threshold of LBO is approximately 18 J/cm² at 355 nm, which is higher than BBO.

Ferroelectric materials, such as periodically poled lithium niobate (PPLN) or magnesium barium fluoride (MgBaF₂), can have their crystal axes flipped via application of a static electric field, allowing for straightforward engineering of a quasi-phase matched material. As stated before, MgBaF₂ has a small nonlinear coefficient, making it unsuitable for quasi-phase matching, and PPLN is not transparent in the DUV. SBO and LBO are not known to exhibit the ferroelectric effect along the c-axis, therefore, alternate methods must be used to quasi-phase-match SBO and LBO.

High quality and quantity single-crystal SBO growth with the Kyropoulos method has been demonstrated using a twin-type stirring blade. LBO can be grown in large boules with high quality with the high-temperature solution top-seeding method. The crystal can be grown by the flux method with a boron trioxide (B₂O₃) self-flux, but with an addition of molybdenum trioxide (MoO₃) to reduce the viscosity of the flux, crystals have been reported in the literature weighing up to 2 kg in size.

Frequency conversion in bulk materials is constrained by the properties of Gaussian beams. In second harmonic generation, for instance, a tighter beam focus will enhance frequency conversion as the generated second harmonic power is proportional to the square of the fundamental power. However, in a tightly focused beam the Rayleigh length is shorter and therefore little crystal length can be utilized for frequency conversion. A less tightly focused beam will have a longer Rayleigh length but will have a lower electric field mode volume which limits conversion efficiency. Dielectric waveguides, on the other hand, guide a small mode volume (thereby with a high electric field) over a long distance limited only by material absorption and surface scattering. Much research has been conducted on lithium niobate (LN) waveguides in the visible and telecom wavelengths, however, LN is not transmissive in the VUV. Furthermore, LN waveguides are often fabricated via ion slicing on SiO₂ on Silicon, or SiO₂ on LN, which are not suitable substrates for wavelengths shorter than 195 nm. Waveguides constructed from SBO or LBO on VUV transparent substrates such as MgF₂, CaF₂, LiF, SBO, LBO, UV fused silica, or Al₂O₃ have not been demonstrated.

The present disclosure generally relates to a system comprising strontium tetraborate (SBO) (SrB₄O₇) or lithium triborate (LBO) (LiB₃O₅) single crystal waveguides for VUV frequency conversion, bonded to a VUV transparent substrate comprising SBO, LBO, calcium fluoride (CaF₂), magnesium fluoride (MgF₂), lithium fluoride (LiF), or silicon dioxide (SiO₂). In this invention, the waveguide dimensions and materials are chosen to phase match the waveguide modes of a fundamental and second harmonic frequency, or three frequencies involved in sum-frequency generation.

In embodiments the waveguide is configured as a slab waveguide (e.g., multimode slab waveguide), a rib waveguide, a ridge waveguide, a whispering gallery mode resonator a ring resonator (e.g., nanoring or microring), or a photonic crystal waveguide. The waveguide may have sloping or straight sidewalls.

In embodiments the waveguide is configured such that it is periodically poled, having alternating regions of c-axis orientation, in order to achieve quasi-phase matching.

In embodiments the waveguide is configured such that alternating sections of the waveguide are amorphous and crystalline. The amorphous sections compensate for the phase mismatch generated in the crystalline region.

In embodiments the waveguide is thick enough to allow the lower frequency(ies) to propagate through the waveguide in a Gaussian beam, and the generated frequency to propagate in a waveguide mode in the crystal. In embodiments the generated frequency is seeded.

These nonlinear crystal waveguides generate light having a DUV wavelength (such as a wavelength between about 120 nm and about 200 nm for SBO and 160 nm and about 200 nm for LBO) at high power while avoiding the above-mentioned problems and disadvantages associated with prior art approaches. Note that in the following description, where a wavelength is mentioned without qualification, that wavelength may be assumed to be the wavelength in vacuum.

An optical system is disclosed, in accordance with one or more embodiments of the present disclosure. In embodiments, the optical system includes an illumination source configured to generate illumination having a wavelength between 120 nm and 200 nm. In embodiments, the optical system includes an optical sub-system configured to direct the illumination from the illumination source onto a sample. In embodiments, the illumination source includes a first fundamental laser configured to generate a fundamental laser beam having a corresponding fundamental frequency and a fundamental wavelength between 720 nm and 800 nm or between 1030 and 1075 nm. In embodiments, the illumination source includes two or more frequency conversion stages, the two or more frequency conversion stages including at least an intermediate frequency conversion stage and a final frequency conversion stage, where the intermediate frequency conversion stage is configured to receive the first fundamental frequency and generate a second frequency light, where the final frequency conversion stage is configured to generate laser output light from the second frequency light, where the final frequency conversion stage includes the nonlinear crystal waveguide configured to double a frequency of the second frequency light, where the nonlinear crystal waveguide includes at least one of strontium tetraborate (SBO) lithium triborate (LBO) crystal plates, and where the waveguide is cooperatively configured to achieve phase matching or quasi-phase-matching (QPM) of the second frequency and doubled second frequency modes.

A laser assembly is disclosed, in accordance with one or more embodiments of the present disclosure. In embodiments, the laser assembly includes a first fundamental laser configured to generate a fundamental laser beam having a corresponding fundamental frequency and a fundamental wavelength between 720 nm and 800 nm or between 1030 and 1075 nm. In embodiments, the illumination source includes two or more frequency conversion stages, the two or more frequency conversion stages including at least an intermediate frequency conversion stage and a final frequency conversion stage, where the intermediate frequency conversion stage is configured to receive the first fundamental frequency and generate a second frequency light, where the final frequency conversion stage is configured to generate laser output light from the second frequency light, where the final frequency conversion stage includes the nonlinear crystal waveguide configured to double a frequency of the second frequency light, where the nonlinear crystal waveguide includes at least one of strontium tetraborate (SBO) lithium triborate (LBO) crystal plates, and where the waveguide is cooperatively configured to achieve phase matching or quasi-phase-matching (QPM) of the second frequency and doubled second frequency modes.

An outcoupling prism is disclosed, in accordance with one or more embodiments of the present disclosure. In embodiments, the prism is composed of the same crystal as the waveguide core. In embodiments the input surface of the prism is placed so that it is touching the waveguide. In embodiments the input surface is placed so that there is a small gap between the waveguide and the prism. In embodiments, the crystal axes orientation in the prism and the propagation direction of the generated light is chosen such that the accessed nonlinear coefficients are zero or small to prevent frequency conversion or down-conversion. In embodiments, the output surfaces of the prism are cut at Brewster's angle for each outcoupling frequency at the exit location of each frequency.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the present disclosure.

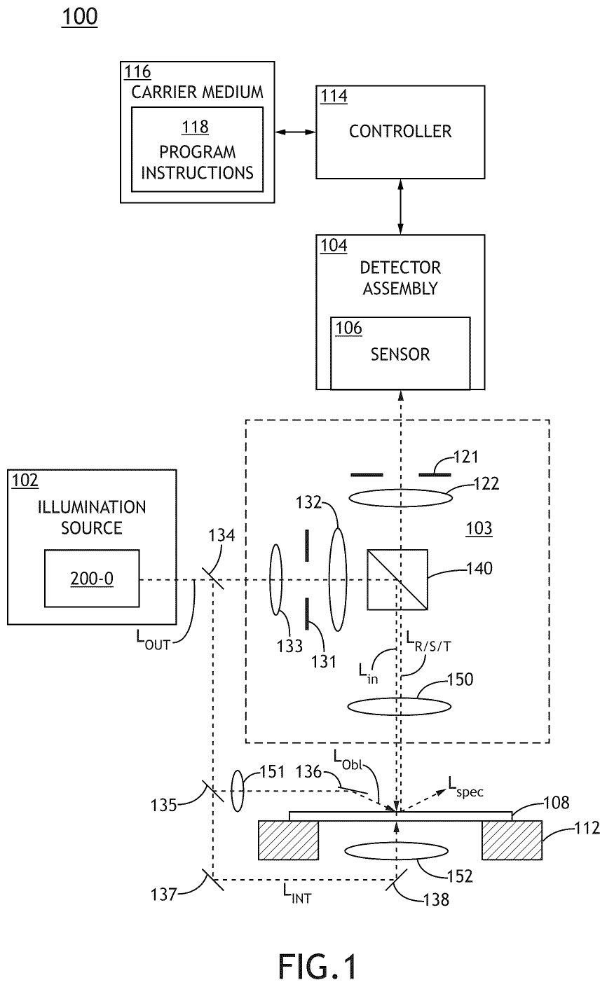

FIG. 1 illustrates a simplified block diagram of an optical system 100, in accordance with one or more embodiments of the present disclosure. The optical system 100 may be configured as an inspection system or a metrology system for inspecting a sample 108 and/or acquiring optical metrology measurements from the sample 108. The optical system 100 may include a semiconductor fabrication system. For example, the optical system may include a fabrication system that may be configured to cut, drill or ablate material from sample 108, or to expose a pattern onto photoresist on sample 108.

The sample 108 may include any sample known in the art such as, but not limited to, a wafer, reticle, photomask, or the like. In embodiments, the sample 108 may be disposed on a stage assembly 112 to facilitate movement of the sample 108. The stage assembly 112 may include any stage assembly known in the art including, but not limited to, an X-Y stage, an R-θ stage, and the like. In embodiments, the stage assembly 112 is capable of adjusting the height of the sample 108 during inspection to maintain focus on the sample 108. In embodiments, a lens such as objective lens 150 may be moved up and down during inspection to maintain focus on the sample 108.

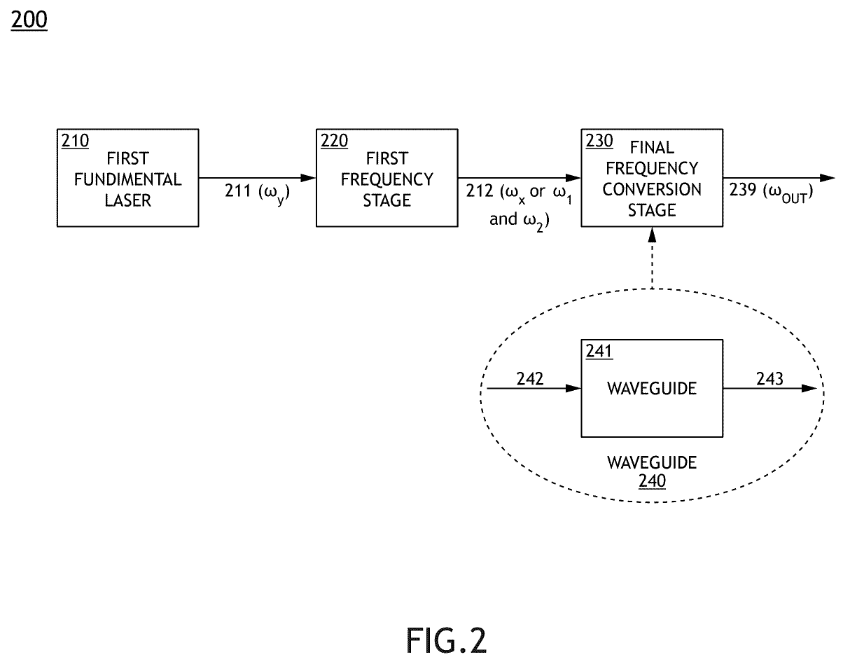

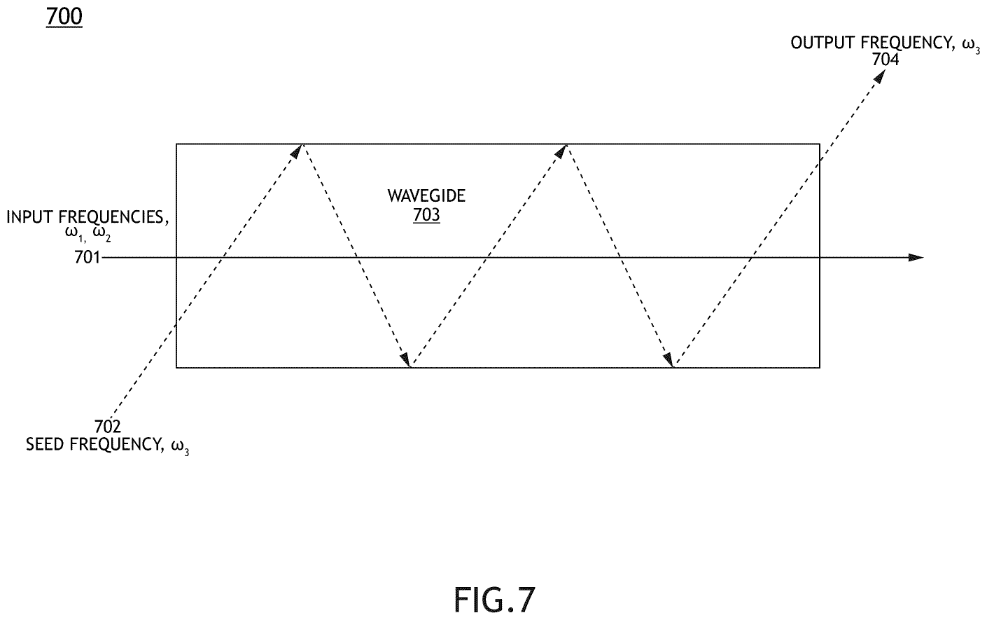

In embodiments, the optical system 100 includes an illumination source 102 that incorporates a laser 200-0 that generates output light L_{OUT} having an output frequency ω_{OUT} with a corresponding a wavelength in a range between approximately 120 nm and approximately 200 nm. Details of an exemplary laser 200-0 can be found in the description of FIGS. 2 and 7. Laser 200-0 incorporates at least one of an SBO and an LBO quasi-phase matched crystal as grown using the methods described herein. Illumination source 102 may include additional light sources such as a laser operating at a longer or shorter wavelength or a broadband light source.

In embodiments, the optical system 100 includes one or more optical components such as, but not limited to, beam splitters, mirrors, lenses, apertures and waveplates that are configured to condition and direct light L_{OUT} to sample 108. The optical components may be configured to illuminate an area, a line, or a spot on sample 108. In embodiments beam splitter or mirror 134, mirrors 137 and 138 and lens 152 are configured to illuminate sample 108 from below so as to enable inspection or measurement of sample 108 by transmitting light LINT through the sample. In embodiments, beam splitters or mirrors 134 and 135, mirror 136 and lens 151 are configured to illuminate sample 108 with light at an oblique angle of incidence L_{obl}, for example at an angle of incidence greater than 60° relative to a normal to the sample surface. In this embodiment, the specularly reflected light L_{Spec} may be blocked or discarded rather than collected. In embodiments, optics 103 are collectively configured to direct illumination light LIN to the top surface of sample 108.

When the sample 108 is illuminated in one or more of the above described modes, the optics 103 are also configured to collect light L_{R/S/T} reflected, scattered, diffracted, transmitted and/or emitted from the sample 108 and direct and focus the light L_{R/S/T} to sensor 106 of a detector assembly 104. It is noted herein that sensor 106 and the detector assembly 104 may include any sensor 106 known in the art. For example, the sensor 106 may include, but is not limited to, a charge-coupled device (CCD) detector, a complementary metal oxide semiconductor (CMOS) detector, a time-delay integration (TDI) detector, a photomultiplier tube (PMT), an avalanche photodiode (APD), a line sensor, an electron-bombarded line sensor, or the like. The detector assembly 104 may be communicatively coupled to a controller 114.

The controller 114 may be configured to store and/or analyze data from detector assembly 104 under control of program instructions 118 stored on carrier medium 116. The controller 114 may be further configured to control other elements of inspection system 100 such as stage 112, illumination source 102 and optics 103.

In embodiments, the optics 103 includes an illumination tube lens 133. The illumination tube lens 132 may be configured to image an illumination pupil aperture 131 to a pupil within an objective lens 150. For example, the illumination tube lens 132 may be configured such that the illumination pupil aperture 131 and the pupil within the objective lens 150 are conjugate to one another. In embodiments, the illumination pupil aperture 131 may be configurable by switching different apertures into the location of illumination pupil aperture 131. In embodiments, the illumination pupil aperture 131 may be configurable by adjusting a diameter or shape of the opening of the illumination pupil aperture 131. In this regard, the sample 108 may be illuminated by different ranges of angles depending on the characterization (e.g., measurement or inspection) being performed under control of the controller 114. The illumination pupil aperture 131 may also include a polarizing element to control the polarization state of the illumination light LIN.

In embodiments, the one or more optical elements 103 include a collection tube lens 122. For example, the collection tube lens 122 may be configured to image the pupil within the objective lens 150 to a collection pupil aperture 121. For instance, the collection tube lens 122 may be configured such that the collection pupil aperture 121 and the pupil within the objective lens 150 are conjugate to one another. In embodiments, the collection pupil aperture 121 may be configurable by switching different apertures into the location of collection pupil aperture 121. In embodiments, the collection pupil aperture 121 may be configurable by adjusting a diameter or shape of the opening of collection pupil aperture 121. In this regard, different ranges of angles of illumination reflected or scattered from the sample 108 may be directed to detector assembly 104 under control of the controller 114. The collection pupil aperture 121 may also include a polarizing element so that a specific polarization of light L_{R/S/T} can be selected for transmission to sensor 106.

In embodiments, the illumination pupil aperture 131 and/or the collection pupil aperture 121 may include a programmable aperture.

The various optical elements and operating modes depicted in FIG. 1 are merely to illustrate how laser 200-0 may be used in inspection system 100 and are not intended to limit the scope of the present disclosure. A practical optical system 100 may implement a subset or a superset of the modes and optics depicted in FIG. 1. Additional optical elements and subsystems may be incorporated as needed for a specific application. The related references cited above, and the other references cited herein disclose many other important details of systems that may incorporate the laser 200-0.

FIG. 2 is a simplified block diagram depicting a laser assembly 200 configured to generate a wavelength in the range of approximately 120 nm to approximately 200 nm (e.g., approximately 193 nm) according to an embodiment of the present disclosure.

In embodiments, the laser assembly 200 includes a first fundamental laser 210 and two frequency doubling (conversion) stages (i.e., one intermediate frequency doubling stage 220, and a final frequency doubling stage 230) that are cooperatively configured to generate laser output light 239 having a wavelength in the range of approximately 120 nm to approximately 200 nm. The first fundamental laser 210 is configured to generate fundamental light 211 having a first fundamental wavelength in the range of approximately 720 nm to approximately 800 nm and a corresponding first fundamental frequency ω_{y}. The first frequency doubling stage 220 receives the first fundamental light 211 and generates second harmonic light 212 with a second harmonic frequency ωₓ equal to twice the first fundamental frequency ω_{y}. The final (second) frequency doubling stage 230 receives the second harmonic light (intermediate frequency light) 212 and generates the laser output light 239 with an output frequency ω_{OUT} that is equal to four times the first fundamental frequency ω_{y}.

Referring to FIG. 2, the first fundamental laser 210 is configured using any suitable technique to generate the first fundamental light 211 (“fundamental”) at the first fundamental frequency ω_{y}. In embodiments, the first fundamental laser 210 is configured such that the first fundamental light 211 is generated at a first fundamental frequency ω_{y} corresponding to a wavelength between approximately 720 nm and approximately 800 nm (such as a wavelength of approximately 774 nm). In embodiments, the first fundamental laser 210 is implemented using a titanium-sapphire (Ti-sapphire) lasing medium. Suitable fundamental lasers operating at wavelengths near 800 nm are commercially available from Spectra-Physics and other manufacturers. In order to generate sufficient light at a wavelength of approximately 193 nm for inspecting semiconductor wafers, reticles or photomasks, it is contemplated herein that the first fundamental laser 210 should generate tens or hundreds of Watts of fundamental light 211. Other applications may not require so much power or may need more power. Depending on the pulse width and repetition rate requirements for laser 200-0, the first fundamental laser may be configured as a Q-switched laser, a mode-locked laser or a CW laser.

The first frequency conversion (doubling) stage 220 may be configured to generate second harmonic light 212 from the first fundamental light 211. In embodiments, the first frequency conversion (doubling) stage 220 incorporates a lithium triborate (LBO) nonlinear crystal configured for critical phase matching of the first fundamental frequency and the second harmonic frequency. The first frequency conversion (doubling) stage 220 may include other components as necessary, such as a prism for separating the second harmonic light 212 from unconsumed fundamental light. The first frequency conversion (doubling) stage 220 may include a cavity resonant at the first fundamental frequency to increase the conversion efficiency.

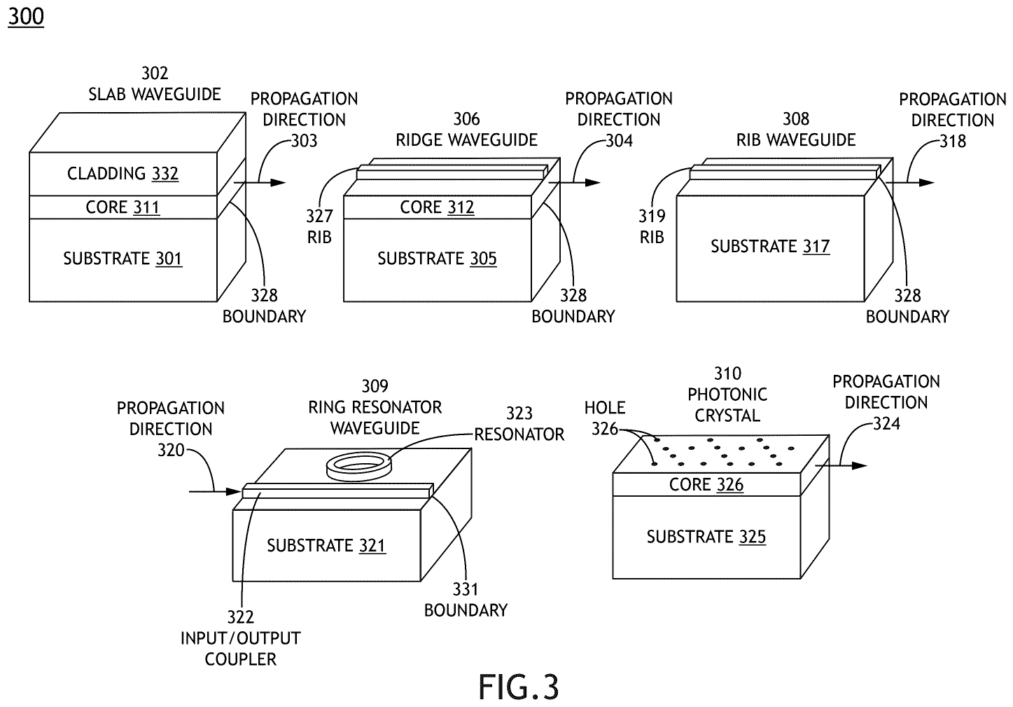

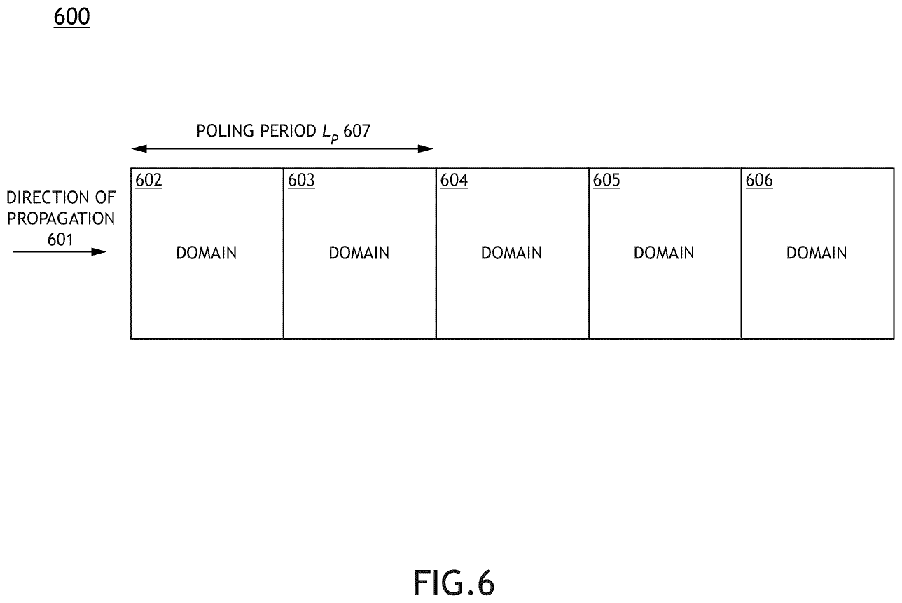

The final frequency conversion (doubling) stage 230 may be configured to generate laser output light 239 from the second harmonic light 212. The final frequency conversion (doubling) stage 230 may incorporate a nonlinear waveguide 241 configured to double the frequency of the second harmonic light 212, and to output light 243 that includes light at the frequency of the laser output light 239 and unconsumed second harmonic light. The nonlinear waveguide 241 may be comprised of one of SBO or LBO. These and other important aspects of the nonlinear waveguide are described in detail below in relation to FIGS. 3 and 6.

The final frequency conversion (doubling) stage 230 may include other optical components as necessary, such as a prism for separating the laser output light 239 from unconsumed fundamental and second harmonic light. The final frequency conversion (doubling) stage 230 may include a cavity to recirculate the second harmonic frequency to increase the conversion efficiency.

In embodiments, a single cavity may include both a first frequency conversion stage 220 and a final frequency conversion stage 230. In embodiments, the first fundamental laser 210 includes a laser with output frequency 211 of approximately 1000 nm, such as 1064 nm or 1030 nm. In embodiments, the first frequency conversion stage 220 includes sum-frequency generation, sum-difference generation, optical parametric oscillation, or optical parametric amplification stages. In embodiments, the final frequency conversion stage 230 includes a sum-frequency generation stage with frequency conversion waveguide 241, as described further in the description of FIGS. 3, 7.

Table 1 lists wavelengths used by the laser assemblies 200-0 and 200 of FIGS. 1 and 2 to generate laser output light L_{OUT} and 239 with wavelength approximately in the range of 125 nm to 140 nm (e.g., approximately 133 nm), 147 nm to 155 nm (e.g., approximately 152 nm), 170 nm to 180 nm (e.g., approximately 177 nm), and with wavelength approximately in the range of 190 nm to 195 nm (e.g., approximately 193 nm), in accordance with exemplary embodiments of the present disclosure. For the fundamental laser type, an exemplary fundamental wavelength is shown, along with the wavelengths corresponding to the harmonics. The exact wavelength of a fundamental laser depends on many factors including the exact composition of the lasing medium, the operating temperature of the lasing medium, and the design of the optical cavity. Two lasers using the same laser line of a given lasing medium may operate at wavelengths that differ by a few tenths of 1 nm or a few nm due to the aforementioned and other factors. One skilled in the appropriate arts would understand how to choose the appropriate first and second fundamental wavelengths in order to generate the desired output wavelength from any fundamental wavelength close to those listed in the table. Similarly, if the desired output wavelength differs from 133 nm by a few nm, 152 nm by a few nm, from 177 nm by a few nm, or from 193 nm by a few nm, the desired output wavelength can also be achieved by an appropriate adjustment of the wavelength for the first or the second fundamental wavelength.

TABLE 1

| Fundamental wavelength(s) | Higher harmonic wavelength |
|---|---|
| (ωₓ or ω₁ and ω₂) | (ωₒᵤₜ) |
| 386 nm | 193 nm |
| 355 nm | 177 nm |
| 532 nm, 266 nm | 177 nm |
| 532 nm, 213 nm | 152 nm |
| 355 nm, 266 nm | 152 nm |
| 266 nm | 133 |

FIG. 3 illustrates details of six exemplary embodiments of waveguides for VUV frequency conversion. In one embodiment, slab waveguide 302 comprises a cladding 332, a core 311, and a substrate 301. Excluding input or output coupling regions, core 311 is of uniform thickness and has a rms surface roughness of less than 5 Å. Core 311 is composed of one of SBO, LBO, or Al₂O₃, the orientation of which will be discussed in more detail. Core 311 is optically contacted to substrate 301 and cladding 332. The boundaries between the core 311 and these two layers have rms surface roughness of less than 5 Å. Substrate 301 is composed of a material different from core 311, and comprises one of calcium fluoride (CaF₂), magnesium fluoride (MgF₂), lithium fluoride (LiF), silicon dioxide (SiO₂), LBO, or SBO. Cladding 332 is composed of a material different from core 311, and comprises one of air or vacuum, calcium fluoride (CaF₂), magnesium fluoride (MgF₂), lithium fluoride (LiF), silicon dioxide (SiO₂), LBO, or SBO.

Efficient second harmonic generation via phase-matching in bulk nonlinear materials occurs when the index of refraction at the fundamental and second harmonic wavelengths is equal (i.e., when both waves travel with the same phase velocity through the crystal). This is possible in certain birefringent crystals for correctly chosen wavelengths, polarizations, propagation angles, and temperatures. Quasi-phase matching (QPM) is utilized in nonlinear crystals with small birefringence or when large nonlinear coefficients are present that are only accessible when the fundamental and second harmonic are co-polarized (such as the large d₃₃ nonlinear coefficient in lithium niobate). In QPM, the phase velocities of the two wavelengths does not match, and instead the sign of the nonlinear coefficient is flipped by alternatingly flipping the crystal orientation, which compensates for the phase-mismatch.

In second harmonic generation in waveguides (without QPM), the effective index (n_{eff}) of the two wavelengths is equal. The effective index is related to β, the z-component of the wavevector of the guided mode in the waveguide, also called the propagation constant, by the relation

$${n}_{eff} = \frac{β}{ω / c} .$$

Here, ω is the radial frequency and c is the speed of light. In order to undergo total internal reflections at interfaces and form a guided mode, the index of the core 311 or guiding medium must be greater than that of the substrate 301 and the cladding 332. Solving Maxwell's equations to find the electric and magnetic fields of the waveguide modes reveals that n_{eff} will have a value less than that of the bulk index of the core and greater than the index of the substrate and cladding. The lowest order mode is the solution to Maxwell's equations with the n_{eff} closest to the core bulk index (i.e. the largest) and that propagates with the “fewest bounces” through the waveguide, and therefore is the mode least sensitive to surface imperfections. Because nonlinear materials (including LBO and SBO) can generally be modeled in their transparent or below bandgap regions by the Sellmeier or Cauchy equations for dispersion, shorter wavelengths have higher indices of refraction in bulk. Therefore, the lowest order mode of the second harmonic will have a larger n_{eff} than the lowest order mode of the fundamental for the same waveguide geometry for the same polarization. In order to perform efficient second harmonic generation in a non-QPM waveguide, the lowest order mode of the fundamental must be matched to a higher order mode of the second harmonic. In order to match the lowest order mode of the fundamental and second harmonic, the difference in n_{eff} of the two modes can be compensated by periodically poling the waveguide material to enable QPM, as discussed in the description accompanying FIG. 6.

The second harmonic conversion efficiency of a nonlinear waveguide is given by

$$η = \frac{{P}_{2 ω}}{{P}_{ω}} = {η}_{norm} {P}_{ω} {L}^{2} , \qquad ( equation 1 )$$

$$where$$

$${η}_{norm} = \frac{8 {π}^{2} {d}_{eff}^{2} {M}_{o}^{2}}{{n}_{ω}^{2} {n}_{2 ω} c {ϵ}_{0} {λ}_{ω}^{2}} sin {c}^{2} ( \frac{Δβ L}{2} ) , \qquad ( equation 2 )$$

where P_{2ω} is the power of the second harmonic, P_{ω} is the power of the fundamental, ηₙₒᵣₘ is the power and length normalized efficiency of the waveguide, L is the length of the waveguide, d_{eff} is the effective nonlinear coefficient (which accounts for QPM if present), Mₒ is the mode overlap described below, n_{ω} is the index of the fundamental frequency, n_{2ω} is the index of the second harmonic frequency, c is the speed of light, ϵ₀ is the permittivity of free space, λ_{ω} is the fundamental wavelength, and Δβ=β_{2ω}−2β_{ω} is the phase mismatch between the fundamental β_{ω} and second harmonic β_{2ω} wavevector components in the direction of propagation 303, 304, 318, and 324. It is further contemplated that the conversion efficiency of the nonlinear waveguide is proportional to the squared length of the waveguide, as opposed to proportional to the length of the crystal as in bulk frequency conversion, making waveguides a more efficient per unit length method for frequency conversion. Of note, equations 1 and 2 use the non-depletion approximation, i.e. when the conversion efficiency is high enough that the fundamental power begins to drop significantly, the equations will need to be modified. In addition to the requirement that the effective indices of the fundamental and second harmonic be equivalent to the 4^{th} or 5^{th} decimal place (depending on the length of the waveguide, which will be discussed later), the fundamental and second harmonic modes must have sufficient electric field overlap, or mode overlap. In the nonlinear wave equation which describes the generation of the second harmonic electric field, the source term is proportional to the square of the fundamental electric field. The conversion efficiency is higher if both the fundamental and second harmonic are both odd modes or both even modes, and will be lowest when one is odd and one is even. The equation for the mode overlap, Mₒ, is

$${M}_{o} = \frac{\int {\int }_{NL} {E}_{2 ω}^{*} ( x , y ) {E}_{ω}^{2} ( x , y ) dxdy}{{[ \int {\int }_{All} {E}_{2 ω}^{2} ( x , y ) dxdy ]}^{\frac{1}{2}} \int {\int }_{All} {E}_{ω}^{2} ( x , y ) dxdy} , \qquad ( equation 3 )$$

where E is the electric field for the subscripted frequency, the integral in the numerator is integrated over a cross-section of the nonlinear material in the waveguide, and the integral in the denominator is integrated over all space. The mode overlap term Mₒ accounts for both the overlap of the fundamental and second harmonic modes with each other and the mode volume containments within the nonlinear medium; any mode volume outside of the nonlinear medium will not contribute to frequency conversion. The polarization of the electric fields and their orientation with respect to the crystal axes and the corresponding nonlinear coefficients is accounted for in the d_{eff} term in equation 2.

The orientation of the nonlinear crystal axes has a large impact on the efficiency of the waveguide. In the case of SBO where the d₃₃ nonlinear coefficient is largest, the fundamental and second harmonic should have parallel polarizations which are parallel to the c-crystal-axis. In a slab waveguide 302 made of SBO, d_{eff} in equation 2 will be equal to the d₃₃ nonlinear coefficient when the fundamental and second harmonic are in a TE guided mode (i.e. the electric field polarization is parallel to the surface plane of the slab), and the c-crystal-axis is parallel to the electric field. If the fundamental and second harmonic are in TM guided modes in an SBO slab waveguide, the c axis should be perpendicular to the plane of the slab surface to maximize the d_{eff}. In this case, the d_{eff} will be lower than in the above-described TE case as the polarization of the frequencies will not always align with the largest d₃₃ nonlinear coefficient. The d₃₃ nonlinear coefficient cannot be accessed efficiently if the fundamental is in a TE mode and the second harmonic in a TM mode or vice versa, although in this case the d₃₂ nonlinear coefficient could be used for frequency conversion assuming the proper axis orientation. To utilize d₃₁, the highest nonlinear coefficient in LBO, the fundamental mode should be a TE mode and the effective index matched second harmonic mode should be a TM mode, or vice versa. The crystal orientation should be chosen such that the c-crystal-axis is perpendicular to the surface plane and the a-crystal-axis is parallel to the surface plane and perpendicular to the direction of propagation 303 of the wave, for a TM second harmonic mode and TE fundamental mode with Type I phase matching. The crystal orientation should be chosen such that the a-crystal-axis is perpendicular to the surface plane and the c-crystal-axis is parallel to the surface plane and perpendicular to the direction of propagation 303 of the wave, for a TE second harmonic mode and TM fundamental mode or a TE second harmonic mode and TE/TM fundamental mode for Type II phase matching.

Derived from equation 1 and 2, the waveguide efficiency η is proportional to

$${L}^{2} sin {c}^{2} ( \frac{Δ kL}{2} ) = {L}^{2} sin {c}^{2} ( 2 πΔ {n}_{eff} L ) .$$

Therefore, the effective index difference between the fundamental and second harmonic, Δn_{eff}, must be less than 1×10⁻⁴ for waveguides 1 mm in length and greater, preferably less than 1×10⁻⁵. Tuning the temperature of the waveguide will slightly change the index of refraction and may help reduce Δn_{eff} if the waveguide dimensions are slightly different from theoretical. The temperature profile of the nonlinear crystal and substrate may be controlled to match effective indices of waveguide modes.

The fabrication of slab waveguide core 311 of uniform thickness may be accomplished by ion slicing or polishing. Ion slicing is a standard method for fabricating lithium niobate waveguides from about 300 nm to several microns thick. In this process, high energy ions, such as helium, hydrogen (H⁺ or H²⁺), oxygen, argon, or others are implanted in the nonlinear material creating a damaged layer a few hundred nanometers thick. After entering the crystal, the ions first undergo primarily electronic interactions which do not damage the lattice, before losing their energy in inelastic collisions with nuclei at a depth determined by the ion energy. These inelastic collisions displace atoms and cause defects in the crystal lattice, creating the damaged layer. Thus, the region above the damaged layer remains largely intact, and ion-induced defect density in this region can be greatly reduced by subsequent annealing steps. The surface is adhered or optically contacted to a handle, either substrate 301 or a solid sacrificial handle, and the crystal is heated or etched to cleave the crystal in the plane of the damaged layer leaving a thin layer of nonlinear crystal attached to a handle. The thin layer is polished to remove any of the remaining damaged layer, and to achieve the correct thickness of the waveguide for matching the effective indices of the desired modes. The slab waveguide may have a thickness between 290 and 330 nm.

In embodiments, core 311 may be fabricated by optically contacting a nonlinear crystal to substrate 301, cleaving the nonlinear crystal so that a thin layer is attached to substrate 301, and polishing the thin layer to the desired thickness and uniformity. Cladding 332 (if not air or vacuum) may be added by optically contacting to core 311 or via a deposition method comprising electron beam evaporation, thermal evaporation, sputtering, atomic layer deposition, chemical vapor deposition, pulsed laser deposition, or another method known to those skilled in the art.

In embodiments, substrate 301 and core 311 are both SBO and boundary 328 is a layer 100 nm or thicker comprising damaged or amorphous SBO, or air pockets. Boundary 328 may be generated by one or multiple steps of ion implantation, as described above. Multiple ion implantation steps performed with different ion energies will generate several damaged layers at boundary 328. This will reduce tunneling losses from the guided modes leaking into the bulk substrate 301. After ion implantation, the crystal may be annealed between 50-1000° C. to repair damage generated by the ion implantation. The damaged layer or boundary 328, having an index less than the undamaged SBO, acts as a lower-index substrate for core 311.

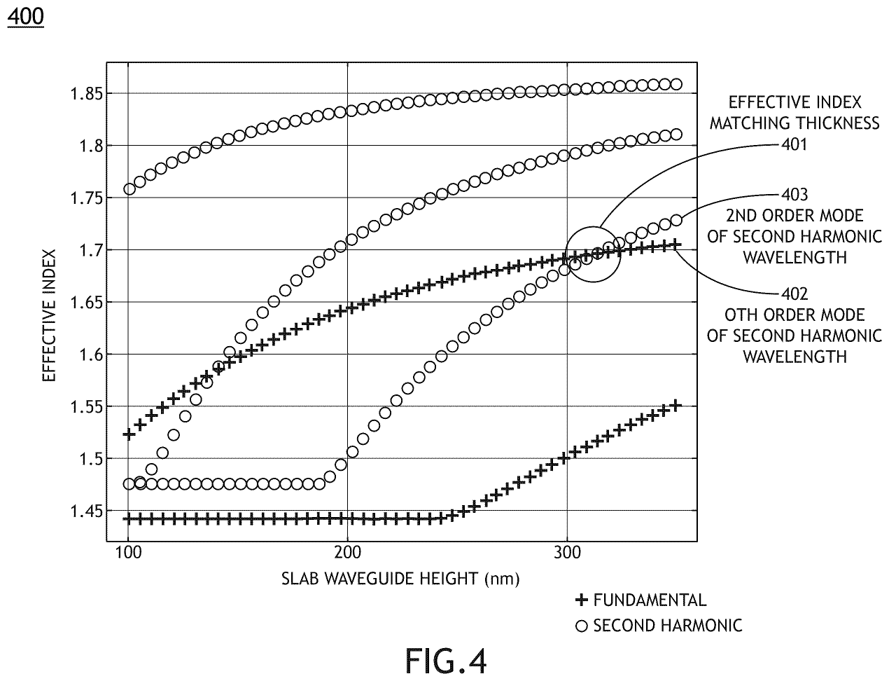

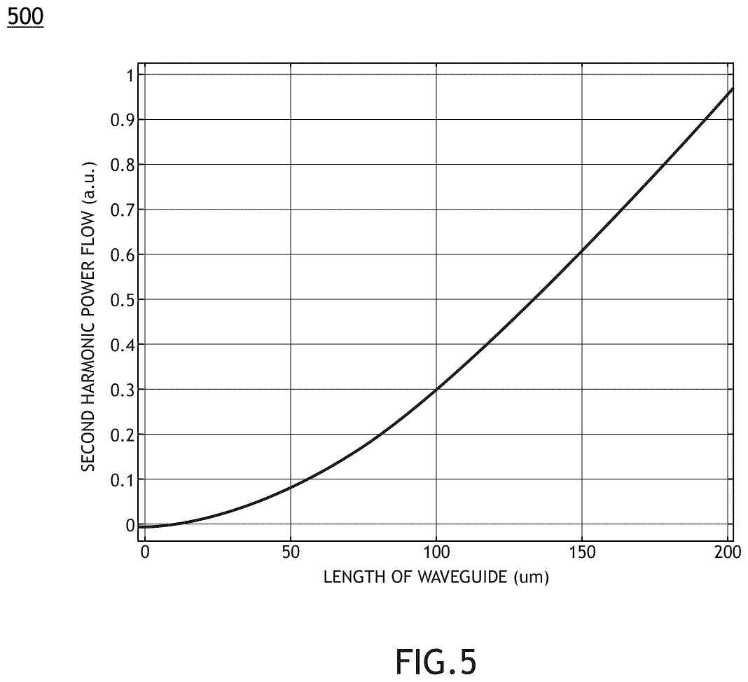

In embodiments, as stated above, substrate 301 must have an index less than core 311 (if boundary 328 is an optical contact). Furthermore, the substrate must be transmissive to the fundamental and second harmonic and have a high damage threshold. This limits the available substrate 301 materials to one of calcium fluoride (CaF₂), magnesium fluoride (MgF₂), lithium fluoride (LiF), silicon dioxide (SiO₂), SBO, or LBO. For efficient frequency conversion waveguide designs, most of the mode volume is contained within the core 311, therefore the second harmonic generated in the substrate will be negligible, if the substrate material has non-zero nonlinear coefficients. Alternatively, the substrate crystal axes orientations can be chosen to eliminate electric field alignment with non-zero nonlinear coefficients. FIGS. 4 and 5 will explore a specific embodiment of a slab waveguide.

In embodiments, cladding 332 and substrate 301 comprise SBO, and core 311 comprises Al₂O₃. Al₂O₃ has a refractive index slightly larger than SBO, but has a centrosymmetric crystal structure and therefore does not have X⁽²⁾ nonlinearity. The electric fields, when not tightly confined in the Al₂O₃ waveguide, will generate a second harmonic field in the SBO cladding and substrate, which can propagate in the Al2O3 waveguide. The crystallographic orientation of the SBO in the cladding 332 and substrate 301 should be the same and in the orientation described above for TE and TM modes in an SBO waveguide.

The benefit of slab waveguide 302 over other waveguide designs is the simplicity of fabrication, design, and the ability to reduce the fundamental power density inside the waveguide as the thickness is only constrained in one dimension. This may keep power densities below the damage threshold of the material or extend the lifetime of the waveguide. Furthermore, surface scattering is reduced as the surface area of this waveguide is less than other designs. In addition, sidewall roughness and slope do not impact performance.

In one embodiment, ridge waveguide 306 is composed of rib 327 on core 312 optically contacted to substrate 305. In embodiments, rib 327 and core 312 are composed of one single crystal of material of one of SBO or LBO, with substrate 305 of smaller index of refraction such as calcium fluoride (CaF₂), magnesium fluoride (MgF₂), lithium fluoride (LiF), silicon dioxide (SiO₂), damaged SBO, or LBO. The majority of the mode volume propagating in direction 304 are contained within the rib 327 and core 312. These embodiments may be fabricated using the methods described in the description for slab waveguide 302, with the addition of a series of lithography, developing, masking, and etching steps to form the rib from the core, as is familiar to those known in the arts.

In embodiments, core 312 is composed of one of SBO or LBO, and rib 327 is composed of a material of higher index than core 312 that is also transparent in the wavelengths of interest, a material such as sapphire (Al₂O₃). Substrate 305 has an index less than core 312. The rib 327 may be designed such that very little of the mode volume resides inside the rib and instead resides in the core 312 composed of the nonlinear material used for frequency conversion. This embodiment benefits from less surface scattering by the geometry and by not needing to etch the core 312 material which may increase surface roughness, in addition to potentially simpler fabrication. Rib 327 may be created by optically contacting or depositing the desired material on Core 312. The deposition method may include atomic layer deposition, electron beam evaporation, sputtering, pulsed laser deposition, molecular beam epitaxy, chemical vapor deposition, or another method known in the arts. This thin layer may then be etched into a rib using steps of lithography, masking, developing, and etching familiar to those skilled in the arts.

Another fabrication method to construct rib 327 may involve performing lithography, masking, and depositing the rib 327 material and subsequently performing liftoff.

In embodiments, substrate 305 and core 312 are both SBO and boundary 329 is a layer 100 nm or thicker comprising damaged or amorphous SBO, or air pockets. Boundary 329 may be generated by ion implantation and annealing as described above in the description of slab waveguide.

In embodiments, rib waveguide 308 comprises rib 319 contacted to substrate 317. Rib 319 is composed of one of LBO or SBO, and substrate 317 is composed of one of calcium fluoride (CaF₂), magnesium fluoride (MgF₂), lithium fluoride (LiF), silicon dioxide (SiO₂), damaged SBO, LBO, or another material transparent to the frequency conversion wavelengths. The benefit of rib waveguide 308 is the tighter confinement of the electric field within the nonlinear material of which the rib is composed of. The rib waveguide 308 can be fabricated in a similar fashion to ridge waveguide 306, where the etching step is continued until substrate 317 is reached. In embodiments, the nonlinear crystal comprises SBO and is configured as a rib waveguide on a calcium fluoride substrate with a rectangular cross-section with a height between 290 and 330 nm and a width between 900 and 1100 nm.

In embodiments, rib 319 is a higher index transparent material, such as sapphire, and substrate 317 is one of LBO or SBO. Rib 319 may be designed such that the fundamental and second harmonic modes have non-negligible power density in the substrate 317. This embodiment may be easier to fabricate.

In embodiments, rib 319 and substate 317 may both be composed of the same nonlinear material, with boundary 330 comprising a damaged or amorphous layer of the same nonlinear material generated through ion implantation, as described above.

In embodiments, ring resonator waveguide 309 comprises a ring or circular resonator 323 of diameter in the range of 100's of nanometers to millimeters, an input/output coupler 322, and a substrate 321. The resonator 323 may be composed of one of SBO or LBO. Substrate 321 may be composed of one of calcium fluoride (CaF₂), magnesium fluoride (MgF₂), lithium fluoride (LiF), silicon dioxide (SiO₂), damaged SBO, LBO, or another material transparent to the frequency conversion wavelengths. Input/output coupler may be composed of one of calcium fluoride (CaF₂), magnesium fluoride (MgF₂), lithium fluoride (LiF), silicon dioxide (SiO₂), SBO, LBO, or another material transparent to the frequency conversion wavelengths. Ring resonators have demonstrated conversion efficiencies of 15% in lithium niobate.

Photonic crystal 310 comprises a core 326 with holes 326 and substrate 325. Core 326 may be composed of one of SBO or LBO. Substrate 325 may be composed of one of calcium fluoride (CaF₂), magnesium fluoride (MgF₂), lithium fluoride (LiF), silicon dioxide (SiO₂), damaged SBO, LBO, or another material transparent to the frequency conversion wavelengths. Input and output coupling in photonic crystal 310 may be achieved with a photonic crystal multiplexer to combine or separate the frequencies involved. Advantages of photonic crystals include the ability to design single-mode waveguides for all frequencies involved, design of large mode sizes to prevent damage or small mode sizes to enhance conversion efficiency, and matching effective indices of the different modes. In addition to the fabrication techniques listed above to create photonic crystal 310, holes 326 may be created via etching or with focused ion beam milling.

In embodiments, waveguides 300 may have a cladding layer comprising air or vacuum, calcium fluoride (CaF₂), magnesium fluoride (MgF₂), lithium fluoride (LiF), silicon dioxide (SiO₂), SBO, LBO, or another material transparent to the frequency conversion wavelengths. This cladding layer may be optically contacted or deposited on the surface of the core, ribs, rings, or other structures comprising the waveguide structures and substrates. This cladding comprises a material with index of refraction less than that of the waveguiding dielectric material.

In a preferred embodiment, the crystal axes of SBO waveguides 300 are oriented such that light propagating inside the SBO waveguides propagates substantially perpendicular to the c-axis with a polarization direction (electric field direction) of light substantially parallel to the c-axis. This utilizes the largest nonlinear coefficient in SBO, d33, and hence maximizes conversion efficiency. In a preferred embodiment utilizing LBO, there is an additional constraint for LBO in that to access the largest nonlinear coefficient, d31, the fundamental polarization direction of light should be substantially parallel to the a-axis in the case of type I phase matching, or parallel to the c- and a-axis in the case of type II phase matching, and the generated harmonic polarization should be substantially parallel to the c-axis for type I and substantially parallel to the a-axis for type II phase matching, in waveguides. Therefore, the LBO crystal waveguides must be cut such that the propagation direction 303, 304, 318, 324 is along the b-axis. The SBO crystal, as the fundamental and generated frequencies both have polarizations substantially parallel to the c-axis, may have propagation direction 303, 304, 318, 324 along the a-axis, the b-axis, or at any angle as long as the c-axis is substantially perpendicular to the propagation direction 303, 304, 318, and 324. In the ring resonator waveguide 309, the preferred embodiment when the resonator 323 is constructed from SBO has a c-axis parallel to the rotational axis of symmetry for the resonator, with fundamental and second harmonic modes polarized along the c-axis.

In embodiments, sum-frequency generation may be performed instead of second-harmonic generation in the waveguides. In this case, the effective indices of the modes may not necessarily match, but the phase mismatch must sum to zero, i.e. Δβ=0=β(ω₃)−β(ω₁)−β(ω₂). Here, β is the wavevector component in the direction of propagation 601 in the nonlinear crystal waveguide given by

$$β ( ω ) = \frac{ω {n}_{eff} ( ω )}{c} , \qquad ( Equation 5 )$$

where n_{eff} is the effective index of refraction of the waveguide mode at the given frequency ω, and c is the speed of light in vacuum. ω₃ is the generated frequency given by ω₃=ω₁+ω₂.

Coupling into and out of waveguides 300 may be done in a number of ways. These include grating coupling, prism coupling, direct coupling with a Brewster cut or anti-reflection coated edge, a tapered waveguide, a photonic crystal multiplexer, or any other method known in the art.

It is noted that while much of present disclosure focuses on embodiments incorporating a nonlinear crystal such examples should not be interpreted as a limitation on the scope of the present disclosure. For example, the frequency conversion waveguide of the present disclosure may include a substrate and a linear crystal optically contacted to the substrate. For instance, the linear crystal may include, but is not limited to, aluminum oxide (Al₂O₃).

FIG. 4 illustrates details of an embodiment of a slab waveguide designed for frequency conversion of 386 nm light to 193 nm light. The calculations for effective indices 400 are shown for different slab waveguide heights and different order modes of the fundamental and second harmonic wavelengths. In the calculations, referring to the slab waveguide 302 diagram in FIG. 3, the substrate 301 is composed of CaF₂ and the core 311 is composed of SBO. The direction of propagation 303 is along the a-axis of SBO, and the z-axis of SBO is parallel to the surface of the slab. The anisotropy of the refractive index of SBO was accounted for in the effective index calculations 400, where were performed with a commercial mode solver. All modes shown in the effective index calculations are TE modes, i.e. the electric field is polarized parallel to the z-axis of the SBO in order to most effectively utilize the high d₃₃ nonlinear coefficient of SBO for second harmonic generation. For a slab waveguide thickness of approximately 312 nm, the 0^{th} order waveguide mode for 386 nm light 402 has the same effective index as the 2^{nd} order mode of 193 nm light 403. This indicates that at that waveguide thickness, both wavelengths will propagate at the same speed through the waveguide allowing phase-matching to occur.

FIG. 5 illustrates details of an embodiment of a slab waveguide designed for frequency conversion of 386 nm light to 193 nm light, as described in the description accompanying FIG. 4, for effective index matching thickness 401, approximately 312 nm. Frequency conversion calculations 500 shows the second harmonic (193 nm) power flow in units of W/m\hat{ }2 in propagation direction 303 (referring to FIG. 3). The power flow is approximately proportional to the length of the waveguide squared, as equations 1 and 2 indicate.

FIG. 6 illustrates details of a quasi-phase-matched waveguide 600. The quasi-phase-matching described may be applied to any waveguides 300 shown in FIG. 3.

In embodiments, waveguides 300 and 600 may be periodically poled in order to quasi-phase-match the lowest order waveguide modes of the fundamental and second harmonic frequencies in second harmonic generation or all three frequencies in sum-frequency generation. Similar to traditional QPM in a bulk material, the phase matching condition for sum-frequency generation in a waveguide is achieved when

$$Δβ = 0 = β ( {ω}_{3} ) - β ( {ω}_{1} ) - β ( {ω}_{2} ) + {β}_{m , eff} \qquad ( Equation 4 )$$

where β is the wavevector component in the direction of propagation 601 in the nonlinear crystal waveguide given by

$$β ( ω ) = \frac{ω {n}_{eff} ( ω )}{c} \qquad ( Equation 5 )$$

where n_{eff} is the effective index of refraction of the waveguide mode at the given frequency ω, and c is the speed of light in vacuum. ω₃ is the generated frequency given by ω₃=ω₁+ω₂. In second harmonic generation, ω₁=ω₂ and is the fundamental frequency. β_{m,eff} refers to the wavevector component related to the periodic poling of the material, and is given by

$${β}_{m , eff} = \frac{2 π d}{{L}_{p}} = - β ( {ω}_{3} ) + β ( {ω}_{1} ) + β ( {ω}_{2} ) \qquad ( Equation 6 )$$

where Lₚ is the length of one period of poling 607 (i.e. two domains each with different crystal-axis orientations) and dis an odd integer describing the order of the QPM. Lₚ 607 is chosen to satisfy Equation 6. In both LBO and SBO, the c-axis direction is alternated in each domain to achieve QPM, e.g. domains 602, 604, and 606 will have the c-axis pointing “up” and domains 603 and 605 will have the c-axis pointing in the opposite direction “down”.

In embodiments of waveguides 300 and 600, in place of alternatingly flipping the crystal orientation of each domain when performing quasi-phase-matching with SBO or LBO waveguides, the domains 602-606 may alternate between amorphous (e.g., domains 602, 604, and 606) and crystalline (e.g., domains 603 and 605). This may be achieved by starting with a single-crystal waveguide, and using an electron beam, an ion beam, a laser beam, or another method to melt sections of the waveguide into amorphous glass. The amorphous regions (e.g., domains 602, 604, and 606) will have a similar index to the crystalline regions (e.g., domains 603 and 605) but with a lower or negligible nonlinear coefficient, so the waveguide modes will be maintained in the amorphous region, but the modes of the different frequencies will be uncoupled due to the lack of nonlinear coefficient. Therefore, the phase of the modes will reset in the amorphous region. This embodiment will have lower efficiency than traditional QPM, as the amorphous region does not contribute to frequency conversion but may be easier to fabricate.

FIG. 7 illustrates details of a frequency conversion amplifier 700. In this method, input frequencies ω₁ and ω₂ 701 travel through waveguide 703 as gaussian beams with propagation constants (z-component of wavevector) equal to their k-vectors, i.e. the input frequencies 701 are not in guided modes or do not undergo any total internal reflections from the edges of the waveguide. In order to match the velocities of the input frequencies 701 to the seed frequency ω₃=ω₁+ω₂ 702 appropriately for phase matching, the seed frequency 702 must undergo total internal reflections, or have the effective index of a waveguide mode match the index of the input frequencies 701 in the case of second harmonic generation, or have the difference in propagation constants add to zero, i.e., 0=Δβ=β_{ω}_{₃}−β_{ω}_{₁}−β_{ω}_{₂}=β_{ω}_{₃}−k_{ω}_{₁}−k_{ω}_{₂}. The seed frequency 702 must be in a higher order mode in order to lower the effective index to match that of input frequencies 701. Every time the seed frequency 702 passes through the gaussian beam with input frequencies 701, the seed frequency 702 will be amplified. The input frequencies pump energy into the crystal lattice, which is then transferred to the seed frequency passing through.

In embodiments, seed frequency 702 arises from frequency generation from input frequencies 701, with correct k-vector arising from scattering from surface impurities at the input face or waveguide 703 edges, or bulk defects.

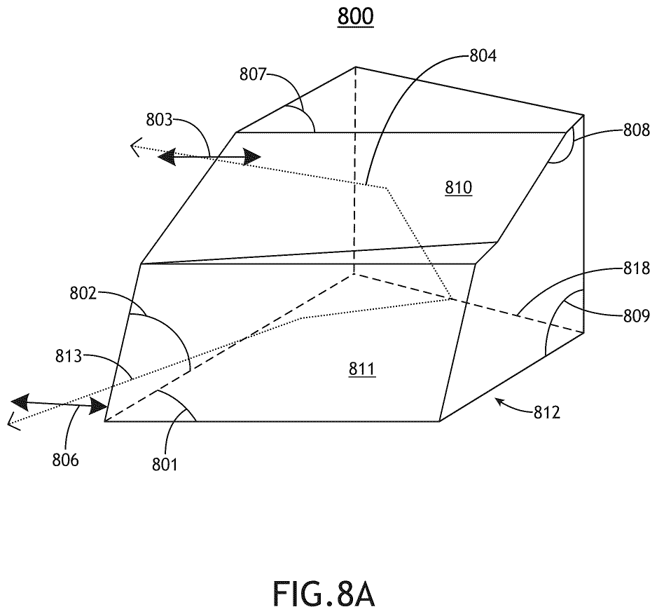

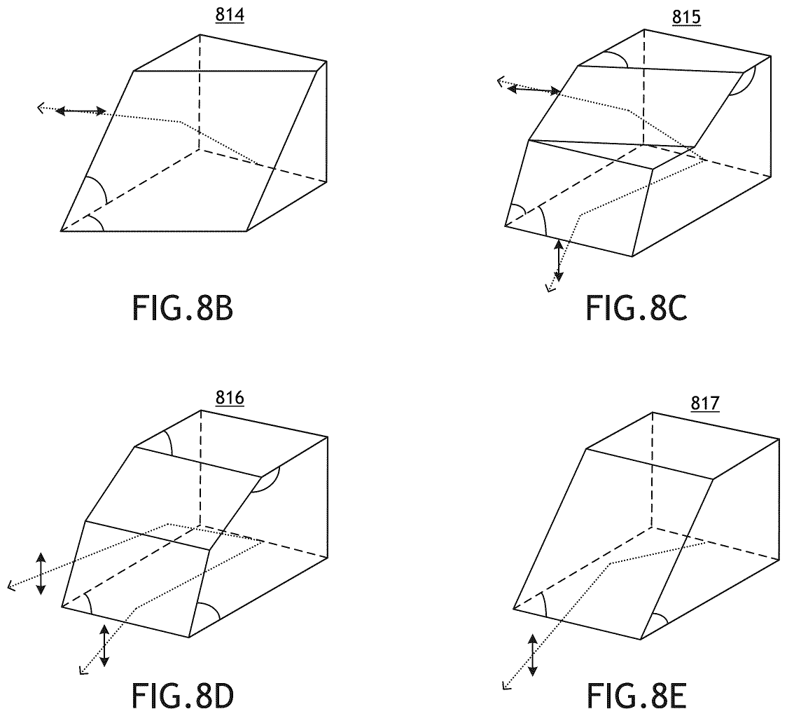

FIG. 8A illustrates the geometric arrangement of an outcoupling prism 800, in accordance with one or more embodiments of the present disclosure. In embodiments, the outcoupling prism 800 may include SBO and/or LBO.

In embodiments, outcoupling prism 800 includes SBO or LBO cut so that the fundamental 813 and second harmonic 804 exit the prism at their respective Brewster's angles. In this regard, facets of the crystal through which light exits the prism may be at Brewster's angle to the light. In embodiments, face 812 is parallel to the waveguide surface, with edge 818 perpendicular to the average propagation direction of the light within the waveguide. Face 812 contacts or nearly contacts the waveguide surface. The distance between face 812 and the waveguide surface may be between zero to hundreds of nanometers to allow for direct or near-field outcoupling of the light from the waveguide into the outcoupling prism 800. The component of the fundamental 813 k-vector in the prism parallel to face 812 will be approximately equal to the propagation constant of the waveguide, which will determine the angle through which the fundamental 813 will travel in the prism. If the fundamental 813 polarization 806 is parallel to face 812, face 811 will intersect a line orthogonal to both the polarization 806 and propagation direction within the prism of fundamental 813. Face 811 will further intersect a line drawn at the Brewster's angle of the fundamental 813 with respect to the propagation direction of fundamental 813 in the plane of the propagation direction of the fundamental 813 and polarization 806. This will allow fundamental 813 to exit the outcoupling prism 800 with minimal reflections. If harmonic 804 is polarized parallel to face 812, a similar process will dictate the orientation of face 810 to minimize reflections of the harmonic 804 when leaving the outcoupling prism 800. Edge 818 will further be a sharp edge without a bevel to increase outcoupling of light.

It is noted that the geometric arrangement as depicted in FIG. 8A is provided merely for illustrative purposes and it is contemplated that a number of outcoupling prism geometries are within the scope of the present disclosure.

FIGS. 8B-8E illustrate outcoupling prisms 814, 815, 816 and 817, in accordance with one or more alternative embodiments.

In embodiments, as depicted in FIG. 8B, prism 814 is cut using the same rules of face 810. For example, face 810 may be cut to maximize outcoupling of the harmonic without regard to the outcoupling of the fundamental. It is noted that outcoupling prism 814 may be simpler and cheaper to fabricate than prism 800.

In embodiments, as shown in FIG. 8C, prism 815 is designed to Brewster couple the fundamental and harmonic light having orthogonal or nearly orthogonal polarizations. While prism 815 is depicted as having a vertically polarized fundamental and horizontally polarized harmonic, a prism may be designed in a similar manner to Brewster outcouple a horizontally polarized fundamental and vertically polarized harmonic

In embodiments, as shown in FIG. 8D, prism 816 is designed such that vertically polarized (i.e., polarized perpendicular to edge 818) fundamental and harmonic light will Brewster couple out of the faces of the prism.

In embodiments, as shown in FIG. 8E, prism 817 is designed to Brewster outcouple vertically polarized harmonic light only.

In embodiments, outcoupling prism 800 will be cut such that fundamental 813 or harmonic 804 propagate along the z-crystal axis of the SBO or LBO to minimize further frequency conversion within the prism.

Although embodiments of the present disclosure are described herein using various fundamental wavelengths that facilitate generating laser output light at a desired wavelength between approximately 120-200 nm, other wavelengths within a few or a few tens of nanometers of this desired wavelength can be generated by changing the wavelength of the first fundamental laser (laser 200A). Unless otherwise specified in the appended claims, such lasers and systems utilizing such lasers are considered within the scope of this invention.

Lasers with a wavelength in the sub-200 nm are not commercially available at sufficient power level or are unreliable or expensive to operate. Periodically poled SBO and LBO crystals are not commercially available. In particular, there is no prior art for growing periodically poled crystals with high purity, high damage threshold, high nonlinear coefficient, and high transparency in the sub-200 nm region from a periodically poled seed.

Lasers with a wavelength in the sub-200 nm are not commercially available at sufficient power level or are unreliable or expensive to operate. In particular, there is no prior art other than excimer lasers for generating 1 W of light power or more in a wavelength range between approximately 120 nm and 200 nm. The embodiments of the present invention generate a wavelength between 120-200 nm, therefore provide better sensitivity for detecting small particles and defects than longer wavelengths. The lasers of the present invention do not use toxic or corrosive gasses, and are therefore easier and less expensive to operate and maintain.

One skilled in the appropriate arts will readily appreciate that there are many possible applications of the inventive laser crystals described herein in addition to their use in semiconductor inspection and metrology. For example, a laser operating at a wavelength close to 193.4 nm can be used in a lithography system configured to expose patterns into photoresist coated on a substrate such as a semiconductor wafer. In another example, a laser operating at a wavelength between about 120 nm and 200 nm may be used in a system configured to cut or ablate biological tissue. The lasers described herein can be configured to generate very short pulses at the output wavelength, which can enable preferential removal of material by ablation instead of by heating thereby causing less damage to surrounding material. For example, such lasers may be used in laser eye surgery or laser vision correction. Although the present invention has been described with respect to certain specific embodiments, it will be clear to those skilled in the art that the inventive features of the present invention are applicable to other embodiments as well, all of which are intended to fall within the scope of the present invention.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The description is presented to enable one of ordinary skill in the art to make and use the disclosure as provided in the context of a particular application and its requirements. As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the preferred embodiment will be apparent to those with skill in the art, and the general principles defined herein may be applied to other embodiments. Therefore, the present disclosure is not intended to be limited to the particular embodiments shown and described but is to be accorded the widest scope consistent with the principles and novel features herein disclosed.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A frequency conversion waveguide comprising:
a substrate; and
a nonlinear crystal, wherein the nonlinear crystal comprises at least one of strontium tetraborate (SBO) or lithium triborate (LBO) optically contacted to the substrate.

2. The frequency conversion waveguide of claim 1, wherein the nonlinear crystal comprises SBO and is configured as a slab waveguide on a calcium fluoride substrate, the slab waveguide having a thickness between 290 and 330 nm.

3. The frequency conversion waveguide of claim 1, wherein the nonlinear crystal comprises SBO and is configured as a multimode slab waveguide.

4. The frequency conversion waveguide of claim 1, wherein the nonlinear crystal comprises SBO and is configured as a rib waveguide on a calcium fluoride substrate with a rectangular cross-section with a height between 290 and 330 nm and a width between 900 and 1100 nm.

5. The frequency conversion waveguide of claim 4, wherein the waveguide includes cladding, wherein the cladding comprises at least one of SBO or LBO.

6. The frequency conversion waveguide of claim 1, wherein dimensions and orientation of the nonlinear crystal are configured to achieve phase matching to generate a wavelength of 129-134 nm.

7. The frequency conversion waveguide of claim 1, wherein dimensions and orientation of the nonlinear crystal are configured to achieve phase matching to generate a wavelength of 147-153 nm.

8. The frequency conversion waveguide of claim 1, wherein dimensions and orientation of the nonlinear crystal are configured to achieve phase matching to generate a wavelength of 172-178 nm.

9. The frequency conversion waveguide of claim 1, wherein dimensions and orientation of the nonlinear crystal are configured to achieve phase matching to generate a wavelength of 193 nm.

10. The frequency conversion waveguide of claim 1, wherein the nonlinear crystal is shaped as at least one of a slab, rib, ridge, whispering gallery mode, nanoring or microring resonator, or photonic crystal, with sloping or straight sidewalls.

11. The frequency conversion waveguide of claim 10, wherein the nonlinear crystal comprises a periodically poled nonlinear crystal.

12. The frequency conversion waveguide of claim 11, wherein the periodically poled nonlinear crystal comprises alternating crystalline and amorphous material.

13. The frequency conversion waveguide of claim 1, wherein a temperature profile of the nonlinear crystal and substrate are controlled to match effective indices of waveguide modes.

14. The frequency conversion waveguide of claim 1, wherein the substrate comprises at least one of calcium fluoride, magnesium fluoride, lithium fluoride, silicon dioxide, aluminum oxide, SBO, or LBO.

15. The frequency conversion waveguide of claim 14, wherein the nonlinear crystal comprises SBO and is configured as a slab waveguide with a thickness between 7.5 and 21 microns.

16. The frequency conversion waveguide of claim 1, further comprising:
an outcoupling prism.

17. The frequency conversion waveguide of claim 16, wherein the outcoupling prism comprises a crystal, wherein the crystal comprises at least one of strontium tetraborate (SBO) or lithium triborate (LBO),
wherein a first face of the outcoupling prism is parallel to a surface of the frequency conversion waveguide,
wherein an edge of the outcoupling prism is perpendicular to a propagation direction light within the frequency conversion waveguide.

18. The outcoupling prism of claim 17, wherein facets of the crystal through which light exits the prism are at Brewster's angle to the light.

19. The outcoupling prism of claim 17, wherein a z-crystal axis of the strontium tetraborate or lithium triborate is substantially parallel to the propagation direction of one of the frequencies of light inside the prism.

20. A frequency conversion waveguide comprising:
a substrate; and
a linear crystal, wherein the linear crystal comprises aluminum oxide optically contacted to the substrate.

21. The frequency conversion waveguide of claim 20, wherein the linear crystal comprises aluminum oxide and is configured as a waveguide on an SBO or LBO substrate.

22. The frequency conversion waveguide of claim 21, wherein the waveguide includes cladding, wherein the cladding comprises at least one of SBO or LBO.

23. The frequency conversion waveguide of claim 20, wherein dimension and orientation of the linear crystal are configured to achieve phase matching to generate a wavelength of 129-134 nm.

24. The frequency conversion waveguide of claim 20, wherein dimensions and orientation of the linear crystal are configured to achieve phase matching to generate a wavelength of 147-153 nm.

25. The frequency conversion waveguide of claim 20, wherein dimensions and orientation of the linear crystal are configured to achieve phase matching to generate a wavelength of 172-178 nm.

26. The frequency conversion waveguide of claim 20, wherein dimensions and orientation of the linear crystal are configured to achieve phase matching to generate a wavelength of 193 nm.

27. The frequency conversion waveguide of claim 20, wherein the linear crystal is shaped as at least one of a slab, rib, ridge, whispering gallery mode, nanoring or microring resonator, or photonic crystal, with sloping or straight sidewalls.

28. The frequency conversion waveguide of claim 20, wherein a temperature profile of the linear crystal and substrate is controlled to match effective indices of waveguide modes.

29. The frequency conversion waveguide of claim 20, wherein the substrate comprises at least one of calcium fluoride, magnesium fluoride, lithium fluoride, silicon dioxide, SBO, or LBO.

30. An optical system comprising:
an illumination source configured to generate illumination having a wavelength between 120 nm and 200 nm; and
an optical sub-system configured to direct the illumination from the illumination source onto a sample,
wherein the illumination source comprises:
a first fundamental laser configured to generate a fundamental laser beam having a corresponding fundamental frequency and a fundamental wavelength between 720 nm and 800 nm; and
two or more frequency doubling stages, the two or more frequency doubling stages including at least an intermediate frequency doubling stage and a final frequency doubling stage, the intermediate frequency doubling stage is configured to receive a first fundamental frequency and generate a second harmonic light having a second harmonic frequency, the final frequency doubling stage is configured to generate laser output light from the second harmonic light, the final frequency doubling stage includes a nonlinear crystal waveguide configured to double a frequency of the second harmonic light,
wherein the nonlinear crystal waveguide is composed of at least one of strontium tetraborate (SBO), or lithium triborate (LBO),
wherein the nonlinear crystal waveguide is configured to phase match or quasi-phase-match the second harmonic frequency and the laser output light.

31. An outcoupling prism comprising:
a crystal, wherein the crystal comprises at least one of strontium tetraborate (SBO) or lithium triborate (LBO),
wherein a first face of the outcoupling prism is parallel to a surface of a waveguide,
wherein an edge of the outcoupling prism is perpendicular to a propagation direction light within the waveguide.

32. The outcoupling prism of claim 31, wherein facets of the crystal through which light exits the prism are at Brewster's angle to the light.

33. The outcoupling prism of claim 31, wherein a z-crystal axis of the strontium tetraborate or lithium triborate is substantially parallel to the propagation direction of one of one or more frequencies of light inside the prism.
